(19) United States
(12) Patent Application Publication
(10) Pub. No.: US 2004/0189179 A1
(43) Pub. Date: Sep. 30, 2004

(54) Frame for color selection electrode assembly and method of manufacturing color selection electrode assembly

(76) Inventors: Toshikazu Karita, Tokyo (JP); Keizou Makino, Tokyo (JP); Hisakazu Yamane, Tokyo (JP); Yoshimitsu Shiraishi, Tokyo (JP); Kazunari Tsutsui, Tokyo (JP)

Correspondence Address: BIRCH STEWART KOLASCH & BIRCH, PO BOX 747, FALLS CHURCH, VA, 22040-0747, US

(21) Appl. No.: 10/736,597

(22) Filed: Dec. 17, 2003

(30) Foreign Application Priority Data
Mar. 28, 2003 (JP) P2003-090282

(51) Int. Cl. H01J 29/80

(52) U.S. Cl. 313/407

(57) ABSTRACT

A frame (3) for supporting a color selection electrode body (2) under tension includes a pair of first frames (10) arranged in the horizontal direction and a pair of second frames (20) arranged in the vertical direction. The first frames (10) are each formed by bending a sheet material into a substantially triangular sectional shape, whose three side faces are formed by a first support part (12), a second support part (14) and a third support part (16). Projections (30) each having a shear plane (32) are formed in an inner position of the one side edge of the first support part (12). The other side edge (16a)) of the third support part (16) is arranged to be in contact with a main surface of the first support part (12) and the shear plane (32) of each of the projections (30). Shearing force acting between the other side edge (16a)) of the third support part (16) and first support part (12) is received by the projections (30).

### BACKGROUND OF THE INVENTION

1. Field of the Invention

The present invention relates to a technique of securely supporting an electrode used for color selection (hereinafter referred to as “color selection electrode”) in a cathode ray tube (CRT) to which tension is applied in a predetermined direction, that is, a color selection electrode body such as a tensioned shadow mask or aperture grille.

2. Description of the Background Art

Among conventional techniques of supporting a grid which is a color selection electrode is a technique in which support members for supporting a grid are formed in a substantially L-sectional shape and reinforcing plates are welded to the support members, so that the support members are formed in a hollow triangular sectional shape. Such technique is disclosed in, e.g., Japanese Patent No. 3,218,667 (Document 1).

Another technique is known in which two first members for supporting a mask are formed in a hollow triangular sectional shape and are coupled to each other with solid rods or hollow pipes by their respective ends. Such technique is disclosed in, e.g., Japanese Patent Application Laid-Open No. 9-167578 (1997) (Document 2).

Still another technique is known in which frame members are formed of a dual phase stainless steel of relatively high strength for reducing the thickness and weight of the frame members. Such technique is disclosed in, e.g., Japanese Patent Application Laid-Open No. 9-249942 (1997).

Further, a technique in which a shadow mask is welded to external edges of a mask frame is disclosed in, e.g., Japanese Patent Application Laid-Open No. 2000-67748.

Furthermore, a technique is known in which a prescribed portion on one side face of each of triangular pipes for supporting a mask is cut away by three sides into a substantially U-shape and the prescribed portion is bent up to form a lip, so that the triangular pipe edge is clamped by the lip. Such technique is disclosed in, e.g., National Publication of Translation No. 2002-531919 (Document 3).

However, when forming frames for supporting a color selection electrode body in a hollow triangular sectional shape as described in Documents 1 and 2, the tension of the color selection electrode body causes a shearing force to act upon a connected portion between an oblique face and a side face of each frame. To withstand this shearing force, fillet welding by arc welding or the like needs to be performed on the connected portion between the oblique face and side face of each frame over the entire length of each frame.

However, high-temperature and low-speed welding such as arc welding arises a problem in that thermal strain causes strain deformation at portions of the frames by which the color selection electrode body is supported.

On the other hand, in Document 3, a prescribed portion on one side face of a triangular pipe is cut away by three sides into a substantially U-shape and the prescribed portion is bent up to form a lip, which arises a problem in that the triangular pipe edge digs into the lip under a high shearing force resulting from a high tension of the color selection electrode body, resulting in deformation of the lip. Thus, deformation of the triangular pipe due to the shearing force cannot be prevented.

### SUMMARY OF THE INVENTION

It is an object of the present invention to provide a technique of obtaining a rigid frame with as short a weld length as possible.

A first aspect of the invention is directed to a frame for a color selection electrode assembly for supporting a color selection electrode body under tension. The frame includes at least two support parts joined together at a predetermined angle. At least one projection having a convex surface and at least one shear plane is formed on one of the support parts. An edge of the other one of the support parts is arranged to be in contact with one main surface of the one of the support parts and the shear plane.

Since at least one projection having the convex surface and at least one shear plane is formed on the one of the support parts and the edge of the other one of the support parts is arranged to be in contact with one main surface of the one of the support parts and the shear plane, a force acting upon the one of the support parts is received by the projection. Therefore, the frame can be rigidified with as short a weld length as possible.

Particularly since the edge of the other one of the support parts is in contact with the shear plane of the projection, the edge is unlikely to dig into the projection. Therefore, the frame can sufficiently be rigidified.

A second aspect of the invention is directed to a frame for a color selection electrode assembly for supporting a color selection electrode body under tension. The frame includes a pair of first frames and a pair of second frames for holding the pair of first frames substantially in parallel to each other with a predetermined space therebetween. The pair of first frames are each formed in a substantially triangular sectional shape, each including a first support part having one side edge to which the color selection electrode body is secured, a second support part having one side edge connected to the other side edge of the first support part through a bend, and a third support part having one side edge connected to the other side edge of the second support part through a bend. At least one projection having a convex surface and at least one shear plane is formed in an inner position of the one side edge of the first support part, and the other side edge of the third support part is arranged to be in contact with a main surface of the first support part and the shear plane.

Since at least one projection having the convex surface and at least one shear plane is formed in the inner portion of the one side edge of the first support part and the other side edge of the third support part is arranged to be in contact with the main surface of the first support part and the shear plane, a force acting upon the first support part is received by the projection. Therefore, the frame can be rigidified with as short a weld length as possible.

Particularly since the other side edge of the third support part is in contact with the shear plane of the projection, the other side edge is unlikely to dig into the projection. Therefore, the frame can sufficiently be rigidified.

A third aspect of the invention is directed to a frame for a color selection electrode assembly for supporting a color selection electrode body under tension. The frame includes a pair of first frames and a pair of second frames for holding the pair of first frames substantially in parallel to each other with a predetermined space therebetween. The pair of first frames are each formed in a substantially triangular sectional shape, each including a frame body in a substantially L-sectional shape having a first support part having one side edge to which the color selection electrode body is secured and a second support part having one side edge connected to the other side edge of the first support part through a bend, and a third support part for covering an open side of the frame body opposite to the bend. At least one first projection having a convex surface and at least one shear plane is formed in an inner position of the one side edge of the first support part, while at least one second projection having a convex surface and at least one shear plane is formed in an inner position of the other side edge of the second support part. The one side edge of the third support part is arranged to be in contact with a main surface of the second support part and the shear plane of the second projection, while the other side edge of the third support part is arranged to be in contact with a main surface of the first support part and the shear plane of the first projection.

Since the one side edge of the third support part is arranged to be in contact with the main surface of the second support part and the shear plan of the second projection, a force acting upon the second support part is received by the second projection. Also, since the other side edge of the third support part is in contact with the main surface of the first support part and the shear plane of the first projection, a force acting upon the first support part is received by the first projection. Therefore, the frame can be rigidified with as short a weld length as possible.

Further, it is not necessary to bend a sheet material at a relatively sharp angle, which allows the pair of first frames to be manufactured with stable quality.

A fourth aspect of the invention is directed to a method of manufacturing a color selection electrode assembly. The method includes the following steps (a) to (d). The step (a) is to form a pair of first frames and a pair of second frames by pressing a sheet material. The step (b) is to join the pair of first frames and the pair of second frames to form a rectangular frame. The step (c) is to secure a color selection electrode body to the pair of first frames while pressing side faces of the pair of first frames in the direction that they approach each other, and thereafter to release a pressure imposed on the pair of first frames. The step (d) is to perform heat treatment for heating the pair of first frames and the pair of second frames at temperatures ranging from 450 to 500° C. after pressing in the step (a) and before the step (c).

Performing the pressing before the heat treatment can improve press productivity. Also, performing the heat treatment after the pressing allows the frame to be rigidified.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a perspective view of a color selection electrode assembly according to a first preferred embodiment of the present invention;

FIGS. 2A to 2D each illustrate an example of a color selection electrode body;

FIGS. 3A to 3C each illustrate an example of a projection;

FIG. 4 is a cross-sectional schematic view of a first frame according to the first preferred embodiment;

FIG. 5 is a sectional view of a variant of the first frame according to the first preferred embodiment;

FIG. 6 is a perspective view of a color selection electrode assembly according to a second preferred embodiment of the invention;

FIG. 7 is a cross-sectional schematic view of a first frame according to the second preferred embodiment;

FIG. 8 is a sectional view of the first frame according to a variant of the second preferred embodiment;

FIG. 9 is a perspective view of a color selection electrode assembly frame according to a third preferred embodiment of the invention;

FIG. 10 is a perspective view of a color selection electrode assembly frame according to a fourth preferred embodiment of the invention;

FIG. 11 is an explanatory schematic plan view of r a color selection electrode assembly frame according to a fifth preferred embodiment of the invention;

FIG. 12 illustrates a curved shape of a first frame according to the fifth preferred embodiment;

FIG. 13 is an explanatory schematic plan view of a frame according to a comparative example;

FIG. 14 is a perspective view of a color selection electrode assembly frame according to a sixth preferred embodiment of the invention;

FIG. 15 is a perspective view of a color selection electrode assembly frame according to a seventh preferred embodiment of the invention;

FIG. 16A is a perspective view of a color selection electrode assembly frame according to an eighth preferred embodiment of the invention, and FIG. 16B is a sectional view taken along the line A-A of FIG. 16A;

FIG. 17 is a perspective view of a color selection electrode assembly frame according to a ninth preferred embodiment of the invention;

FIG. 18 is a perspective view of a color selection electrode assembly frame according to a variant of the ninth preferred embodiment;

FIG. 19 is a perspective view of a color selection electrode assembly frame according to a tenth preferred embodiment of the invention;

FIG. 20 is a perspective view of a color selection electrode assembly frame according to a variant of the tenth preferred embodiment;

FIG. 21A is an explanatory view of a secured part between a color selection electrode body and a first frame according to an eleventh preferred embodiment of the invention, and FIG. 21B is a partially enlarged view of FIG. 21A;

FIG. 22 is a sectional view of an essential part of a color selection electrode assembly according to a twelfth preferred embodiment of the invention;

FIG. 23 is a sectional view of an essential part of a color selection electrode assembly according to a comparative example;

FIGS. 24A and 24B each illustrate a sectional structure of a weld according to a thirteenth preferred embodiment of the invention; and

FIG. 25 is a flow chart of manufacturing steps of a color selection electrode assembly according to the invention.

### DESCRIPTION OF THE PREFERRED EMBODIMENTS

First Preferred Embodiment

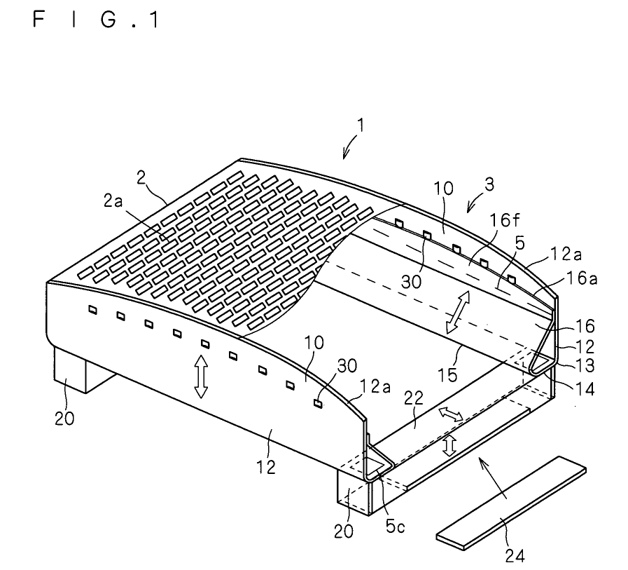

FIG. 1 is a perspective view of a color selection electrode assembly 1 according to a first preferred embodiment of the present invention.

The color selection electrode assembly 1 is one of components of a color selection mechanism in a cathode ray tube (CRT) and includes a color selection electrode assembly frame (hereinafter briefly referred to as “frame”) 3 and a color selection electrode body 2 stretched by the frame 3 under tension.

The color selection electrode body 2 is formed in a thin sheet with a plurality of electron beam holes 2a. FIG. 1 shows only a part that corresponds to substantially a half of a screen. The color selection electrode body 2 is formed, for example, by perforating the electron beam holes 2a on a cold-rolled steel of 0.08 to 0.15 mm thickness by chemical etching.

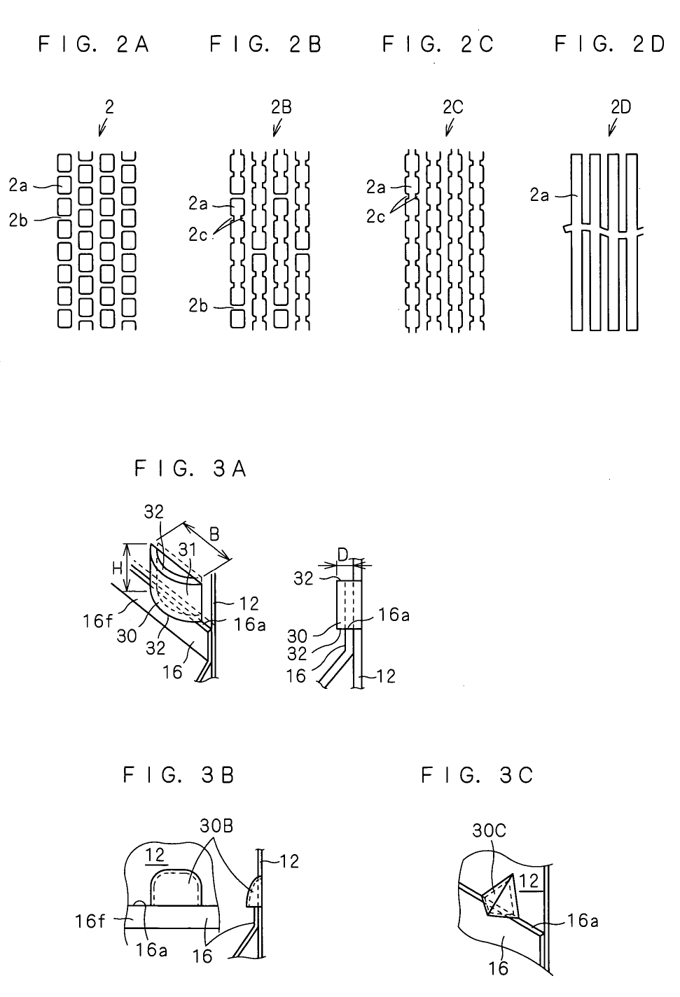

For the color selection electrode body 2, the structure as shown in, for example, FIGS. 1 and 2A is employed in which the plurality of electron beam holes 2a arranged in a plurality of columns in a predetermined direction (here, the vertical direction of the screen) are divided by real bridges (real ties) 2b.

Other examples are: a color selection electrode body 2B shown in FIG. 2B with the plurality of electron beam holes 2a arranged in a plurality of columns in a predetermined direction being coupled to one another by the real bridges 2b or dummy bridges (false ties) 2c; and a color selection electrode body 2C shown in FIG. 2C with the plurality of electron beam holes 2a arranged in a plurality of columns in a predetermined direction being coupled to one another by the dummy bridges 2c. The real bridges 2b are elements extending across the electron beam holes 2a in the widthwise direction thereof for completely separating the electron beam holes 2a from one another. The dummy bridges 2c are elements projecting toward the inside of the electron beam holes 2a in the widthwise direction thereof and not being interconnected at the middle of the electron beam holes 2a in the widthwise direction thereof for incompletely separating the electron beam holes 2a from one another.

Still another example is a color selection electrode body 2D shown in FIG. 2D with the electron beam holes 2a arranged in a plurality of columns in a predetermined direction being formed in slit form without being separated by bridges from one ends to the other ends. The color selection electrode body 2 is not limited to these examples, but is applicable to all electrode bodies with electron beam holes 2a that are supported under a certain degree of tension.

Referring back to FIG. 1, the frame 3 is intended for supporting the color selection electrode body 2 under tension, and includes a pair of first frames 10 and a pair of second frames 20, which are coupled to each other to form a substantially rectangular frame.

Holding members (e.g., holding parts and pin-fit-hole-opened sheet) for aligning the frame 3 with the inner surface of a CRT panel by holding its respective side faces or four corners are provided near the side faces or four corners, illustration of which is omitted here.

The pair of first frames 10 are formed in long lengths, and when incorporated in a CRT, they are arranged to face each other in a substantially horizontal direction with respect to the vertical direction of the screen. The aforementioned color selection electrode body 2 is secured to the first frames 10. The first frames 10 are also called horizontal frames in general.

The first frames 10 each include a first support part 12 of a long, narrow and substantially rectangular shape, a second support part 14 of a long, narrow and substantially rectangular shape and a third support part 16 of a long, narrow and substantially rectangular shape.

The color selection electrode body 2 is secured to one side edge 12a which is one side long edge of the first support part 12. In the present embodiment, the one side edge 12a has a substantially arc shape as viewed in the direction of the normal to the first support part 12 such that the color selection electrode body 2 is supported as a part of the periphery of a cylinder.

The other side edge which is the other side long edge of the first support part 12 is connected to one side edge which is one side long edge of the second support part 14 through a bend 13. The bending angle of the bend 13 is approximately 90 degrees, for example. The other side edge which is the other side long edge of the second support part 14 is connected to one side edge which is one side long edge of the third support part 16 through a bend 15. The bending angle of the bend 15 is smaller than 90 degrees. Further, the other side edge 16a which is the other side long edge of the third support part 16 is arranged to be in contact with a position on one main surface (inner surface) of the first support part 12 on the inner side of the one side edge 12a. In the present embodiment, part of the third support part 16 near the other side edge 16a is formed as a flange 16f slightly bent in such a manner as to come into surface contact with the one main surface of the first support part 12.

The overall configuration of each of the first frames 10 represents a hollow pipe of a substantially triangular sectional shape formed by the first to third support parts 12, 14 and 16. When assembled into the color selection electrode assembly 1, the first support part 12 is held substantially vertically to the color selection electrode body 2, and the second support part 14 is held to extend from the other side edge of the first support part 12 toward the inside of the frame 3 substantially in parallel to the color selection electrode body 2, and the third support part 16 is held to extend transversely with respect to the first and second support parts 12 and 14 while connecting the one side edge 12a of the first support part 12 and the other side edge of the second support part 14.

The first frames 10 are made of a steel sheet of a thickness suitable for sheet-metal press, and are formed, for example, by bending a sheet.

Further, a plurality of projections 30 are provided toward the inside of the frame 3 at a position on the inner side of the one side edge 12a of the first support part 12, more specifically, along the line on which the other side edge 16a of the third support part 16 is to be provided. The number of projections 30 may be at least one.

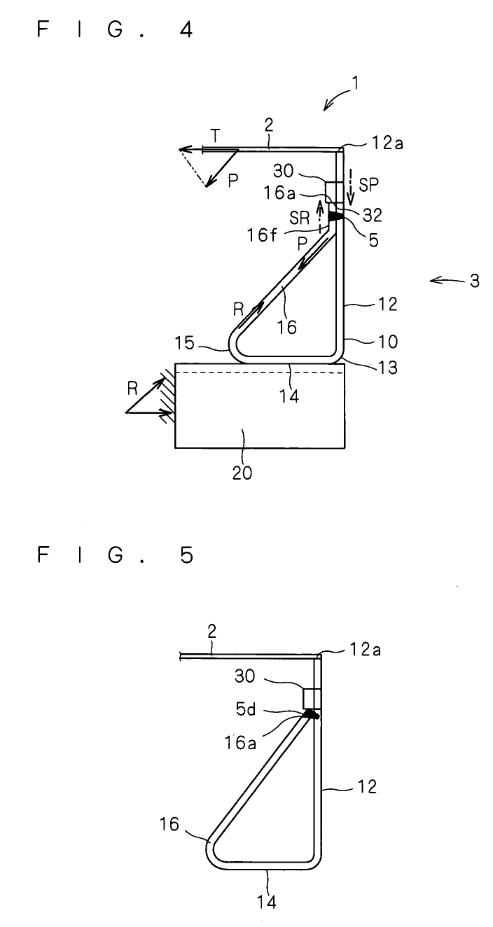

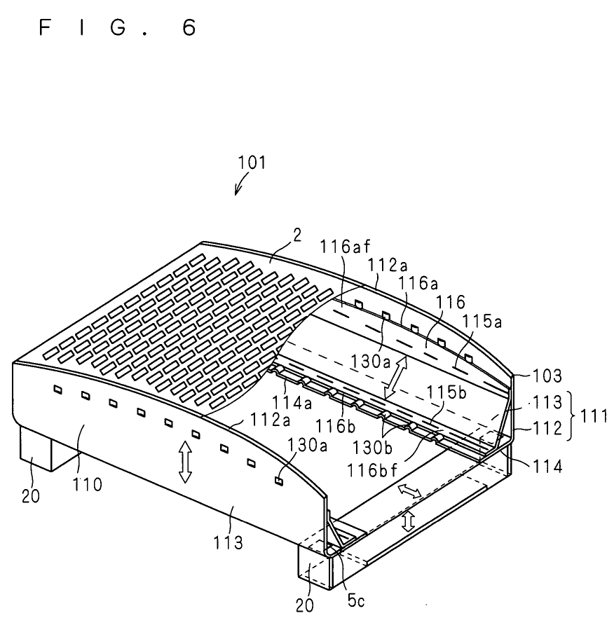

A projection 30 has a convex surface 31 and at least one shear plane 32 as shown in FIG. 3A. Specifically, a substantially rectangular region on the first support part 12 is sheared by two sides which are substantially parallel to the other side edge 16a of the third support part 16 and is punched to form the projection 30 in a substantially partial cylindrical shape. The projection 30 has a width B, a height D and a projecting dimension D.

Another example is a projection 30B shown in FIG. 30B. A substantially semicircular region on the first support part 12 is sheared by one side located adjacent to the other side edge 16a of the third support part 16 and is punched to form a substantially hemispherical shape. Still another example is a projection 30C shown in FIG. 3C. A substantially triangular region on the first support part 12 is sheared by only one side located adjacent to the other side edge 16a of the third support part 16 and is punched to form a triangular pyramid. In short, the projection 30 may be formed by concurrently performing shearing and drawing, and may have one or more shear planes facing the other side edge 16a of the third support part 16.

The other side edge 16a of the third support part 16 is arranged to be in contact with one main surface of the first support part 12 as well as the shear plane 32.

Further, in the present embodiment, the flange 16f near the other side edge 16a of the third support part 16 is in surface contact with the first support part 12, and welding is conducted intermittently at welds 5 along the extending direction of the other side edge 16a.

The pair of second frames 20 have a function of holding the pair of first frames 10 with a predetermined space therebetween substantially in parallel to each other. When incorporated in a CRT, the pair of second frames 20 are provided at the left and right sides of a screen in a substantially vertical direction, which are called vertical frames.

Specifically, the second frames 20 are made of a steel sheet of a thickness suitable for sheet-metal press, and each include a frame body 22 of a long narrow box shape with one side opened and a cover 24 attached to the opening of the frame body 22.

The frame body 22 is formed by, for example, bending a steel sheet into a substantially U-sectional shape, closing its both ends and welding lap joints or edges of members constituting the respective side faces.

The cover 24 is provided for improving the bending strength of the second frames 20, and secured to the opening of the frame body 22 by welding or the like.

In the present embodiment, for easy welding between the first and second frames 10 and 20 as will be described later, the cover 24 does not completely cover the opening of the frame body 22 such that the both end portions of the opening of the frame body 22 remain open when the cover 24 is attached. That is, the cover 24 is attached to the opening of the frame body 22 so as to cover a portion except the both end portions of the opening of the frame body 22.

For the purpose of weight reduction, a steel sheet used for the pair of first frames 10 and pair of second frames 20 is preferably as thin as possible as the strength requirements permit. However, for welding the color selection electrode body 2 with a stable strength, the lowest limit of the sheet thickness is preferably 0.7 mm. When conducting laser welding, for example, for achieving low distortion, the upper limit of the sheet thickness is preferably 1.8 mm (3.6 mm at a lap joint) for the purpose of stably welding two sheets to their reverse sides as well as achieving high productivity (welding speed and energy).

Further, at least one of the extending direction of the bends 13 and 15 of each of the first frames 10 and that of the bends of each of the second frames 20 is preferably set to be substantially perpendicular to the rolling direction of a parent steel sheet of the frames.

That is, bending, by pressing or the like, a dual phase stainless steel sheet or precipitation hardening stainless steel sheet which is generally hard and elongates little is likely to cause cracks along the quarter grain in the rolling direction. This makes it necessary to take some measures such as setting a bend to have a radius three times the sheet thickness or greater. In this case, a problem is likely to arise in that the sheet material cannot be bent with high accuracy.

Therefore, the first and second frames 10 and 20 are formed by bending with the rolling direction being set as hollow arrows shown in FIG. 1, which can prevent cracks only by setting the bend to have a radius approximately 1.2 times to twice the sheet thickness. Thus, the first and second frames 10 and 20 can be obtained with a bending angle of high accuracy.

When assembling the pair of first frames 10 and pair of second frames 20 in a substantially rectangular frame, lap welding is carried out through the openings adjacent to the cover 24 in the state which the second support part 14 of each of the first frames 10 being overlapped with corresponding end portions of the second frames 20 opposite to the openings adjacent to the cover 24. Here, welding is carried out at welds 5c of a substantially rectangular shape. Such welding is performed at the four corners, whereby the frame 3 of a substantially rectangular shape is assembled.

Further, a pair of opposite sides of the color selection electrode body 2 are secured to the one side edge 12a of each of the first support parts 12 by welding or the like. When securing, the pair of first frames 10 are subjected to such force that causes elastic deformation in the direction that the first frames 10 approach each other. After securing, such force is released, when a force that the first frames 10 tend to return to their original positions applies a load to the color selection electrode body 2 that pulls the color selection electrode body 2 outwardly with respect to the frame 3 in the direction substantially perpendicular to the longitudinal direction of the pair of first frames 10.

The operation of the color selection electrode assembly 1 of the aforementioned structure will be described.

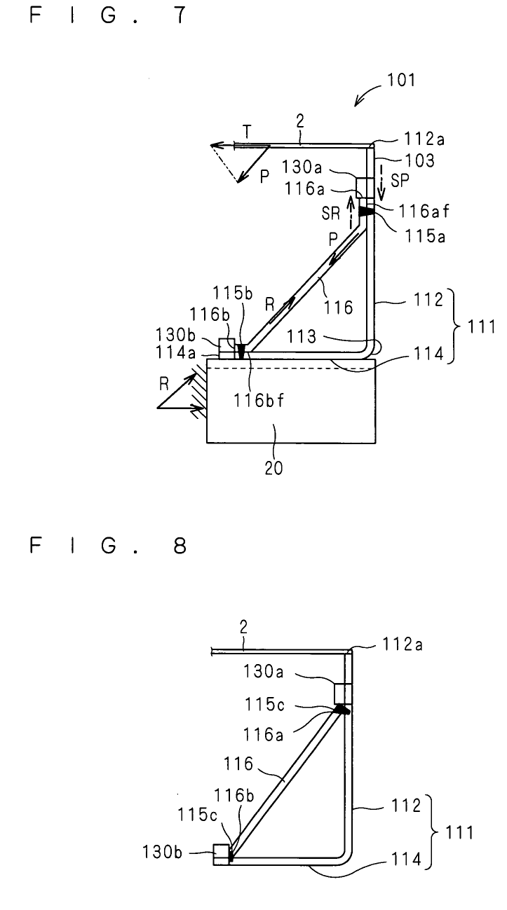

FIG. 4 is a cross-sectional schematic view of the first frame 10. In this drawing, a reaction force with respect to the tension applied to the color selection electrode body 2 is represented by vector T.

In this case, the other side edge 16a of the third support part 16 is in surface contact with one main surface of the first support part 12 while the flange 16f near the other side edge 16a is welded to the first support part 12. A transverse vector P of the reaction force T corresponding to the widthwise direction of the third support part 16 acts upon the third support part 16.

On the other hand, the second frames 20 are respectively attached to the both ends of the first frame 10, and a force in the direction that the second frames 20 approach each other acts upon the first frame 10. Then, provided that the middle portion of each of the second frames 20 in the longitudinal direction is a secured end (hatched part in FIG. 4), a reaction force R acts upon a part of the third support part 16 of the first frame 10 connected to the second support part 14, considering symmetric conditions of load.

Therefore, a shearing force resulting from a vertical component SP of the force P and the vertical component SR of the force R acts upon the weld 5. However, the other side edge 16a of the third support part 16 is in contact with the shear plane 32 of the projection 30, which is thus prevented from moving upward. This can substantially control a shearing stress acting upon the weld 5.

In the above-described color selection electrode assembly 1, the other side edge 16a of the third support part 16 is arranged to be in contact with one main surface of the first support part 12 and the shear plane 32 of the projection 30, which causes the above-mentioned shearing force to be received by the projection 30. This allows rigidification of the frame 3 with the welds 5 provided intermittently, that is, with as short a weld length as possible, without welding the other side edge 16a of the third support part 16 and the first support part 12 over the entire length of each of the first frames 10.

Particularly since the other side edge 16a of the third support part 16 is in contact with the shear plane 32 of the projection 30, the other side edge 16a is unlikely to dig into the projection 30 even under an excessively great shearing force, which allows the frame 3 to be sufficiently rigidified.

In the present embodiment, although lap welding is carried out for each of the first frames 10 with the flange 16f of the third support part 16 and the first support part 12 being overlapped with each other, the flange 16f may be omitted and the edge of a contact portion between the other side edge 16a of the third support part 16 and the first support part 12 may be welded at a weld 5d.

Second Preferred Embodiment

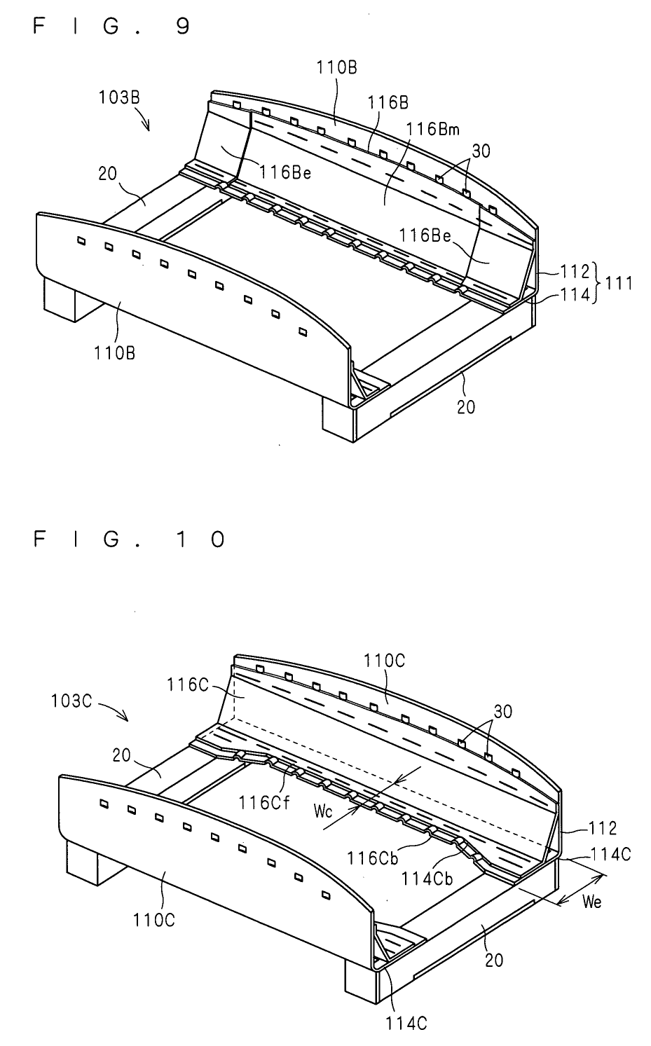

FIG. 6 is a perspective view of a color selection electrode assembly 101 according to a second preferred embodiment of the invention. Components similar to those of the color selection electrode assembly 1 according to the first preferred embodiment are represented by the same reference characters, explanation of which is thus omitted here, and dissimilar points will be described particularly.

The color selection electrode assembly 101 includes a color selection electrode assembly frame (hereinafter briefly referred to as “frame”) 103 and the color selection electrode body 2 stretched by the frame 103 under tension.

The frame 103 is intended for supporting the color selection electrode body 2 under tension, and includes a pair of first frames 110 and the pair of second frames 20 which are coupled to each other to form a substantially rectangular frame.

The pair of first frames 10 are formed of a steel sheet of a thickness suitable for sheet-metal press, and each have a frame body 111 of a substantially L-sectional shape and a third support part 116.

The frame body 111 includes a first support part 112 of a long, narrow and substantially rectangular shape and a second support part 114 of a long, narrow and substantially rectangular shape.

The color selection electrode body 2 is secured to one side edge 112a which is one side long edge of the first support part 112. In the present embodiment, the one side edge 112a has a substantially arc shape as viewed in the direction of the normal to the first support part 112 such that the color selection electrode body 2 is supported as a part of the periphery of a cylinder.

The other side edge which is the other side long edge of the first support part 112 is connected to one side edge which is one side long edge of the second support part 114 through a bend 113. The bending angle of the bend 113 is approximately 90 degrees, for example.

The frame body 111 is formed by bending a sheet material into a substantially L shape. For the same reasons as described in the first preferred embodiment, the extending direction of the bend 113 is preferably set to be substantially perpendicular to the rolling direction of a parent sheet material (i.e., the direction indicated by hollow arrows in FIG. 6).

The third support part 116 is formed in a long, narrow and substantially rectangular shape and is attached to the frame body 111 so as to cover an open side of the frame body 111 opposite to the bend 113.

Further, a plurality of projections 130a are provided inside the first frame 110 at a position on the inner side of the one side edge 112a of the first support part 112, more specifically, along the line on which the other side edge 116a of the third support part 116 is provided.

A plurality of projections 130b are also provided inside the first frame 110 at a position on the inner side of the other side edge 114a of the second support part 114, more specifically, along the line on which the one side edge 116b of the third support part 116 is provided.

The number of projections 130a and 130b may be at least one each.

The projections 130a and 130b each have a similar configuration as the projections 30 or their variant described in the first preferred embodiment.

The other side edge 116a of the third support part 116 is arranged to be in contact with one main surface (inner surface) of the first support part 112 as well as a shear plane of each of the projections 130a. Also, the one side edge 116b of the third support part 116 is arranged to be in contact with one main surface (inner surface) of the second support part 114 as well as a shear plane of each of the projections 130b.

Further, in the present embodiment, a flange 116af near the other side edge 116a of the third support part 116 is in surface contact with the first support part 112, and at the long lapped portion, welding is conducted intermittently at welds 115a along the extending direction of the other side edge 116a. Similarly, a flange 116bf near the one side edge 116b of the third support part 116 is in surface contact with the second support part 114, and at the long overlapped portion, welding is conducted intermittently at welds 115b along the extending direction of the one side edge 116b.

The overall configuration of each of the first frames 110 represents a hollow pipe of a substantially triangular sectional shape with three side walls of the first, second and third support parts 112, 114 and 116. When assembled into the color selection electrode assembly 101, the first support part 112 is held substantially vertically to the color selection electrode body 2, and the second support part 114 is held substantially in parallel to the color selection electrode body 2, extending toward the inside of the frame 103 with respect to the other side edge of the first support part 112, and the third support part 116 is held to extend transversely with respect to the first and second support parts 112 and 114 while connecting the one side edge 112a of the first support part 112 and the other side edge 114a of the second support part 114.

The pair of first frames 10 and the pair of second frames 20 are joined to each other as described in the first preferred embodiment, and are assembled into the frame 103. Then, as in the first preferred embodiment, the color selection electrode body 2 is secured to the frame 103.

The operation of the color selection electrode assembly 101 of the aforementioned structure will be described.

FIG. 7 is a cross-sectional schematic view of the first frame 110. In this drawing, a reaction force with respect to the tension applied to the color selection electrode body 2 is represented by vector T.

In this case, as in the first preferred embodiment, a shearing force resulting from a vertical component SP of the force P and the vertical component SR of the force R acts upon the weld 115a between the other side edge 116a of the third support part 116 and the first support part 112. However, the other side edge 116a is in contact with the shear plane of the projection 130a, which is thus prevented from moving upward. This can substantially control the shearing stress acting upon the weld 1154a.

Likewise, a shearing force acts upon the weld 115b between the one side edge 116b of the third support part 116 and the second support part 114. However, the one side edge 116b is in contact with the shear plane of the projection 130b, which is thus prevented from moving upward. This can substantially control the shearing stress acting upon the weld 115b.

In the above-described color selection electrode assembly 101, the other side edge 116a of the third support part 116 is arranged to be in contact with one main surface of the first support part 112 and the shear plane of the projection 130a, which causes the above-mentioned shearing force to be received by the projection 130a. This allows rigidification of the first frames 110 with the welds 115a provided intermittently, that is, with as short a weld length as possible, without welding the other side edge 116a of the third support part 116 and the first support part 112 over the entire length of each of the first frames 110.

Likewise, the one side edge 116b of the third support part 116 is arranged to be in contact with the main surface of the first support part 112 and the shear plane of the projection 130b, which causes the above-mentioned shearing force to be received by the projection 130b. This allows rigidification of the first frames 110 with the welds 115b provided intermittently, that is, with as short a weld length as possible, without welding the one side edge 116b of the third support part 116 and the second support part 114 over the entire length of each of the first frames 110.

Particularly in the present embodiment, since a sheet material is not required to be bent at a relatively sharp angle, the problem of control of cracks and spring back can be prevented because of a slight increase in the number of components caused by forming the third support part 116 of a different material and an increase in welds by the presence of the welds 115b, which results in an advantage in that the first frames 110 can be manufactured with stable quality.

In other words, in the first preferred embodiment, when the second support part 14 and third support part 16 are bent at a sharp angle (particularly when the radius of the bend is smaller than the sheet thickness), cracks occur. Further, in the first preferred embodiment, control of spring back is necessary in order to reliably bring the flange 16f into surface contact with the first support part 12 for achieving stable welding at the weld 5.

On the other hand, in the present embodiment, a sheet material is not required to be bent at a relatively small angle, i.e., a sharp angle, which solves the above-described problem.

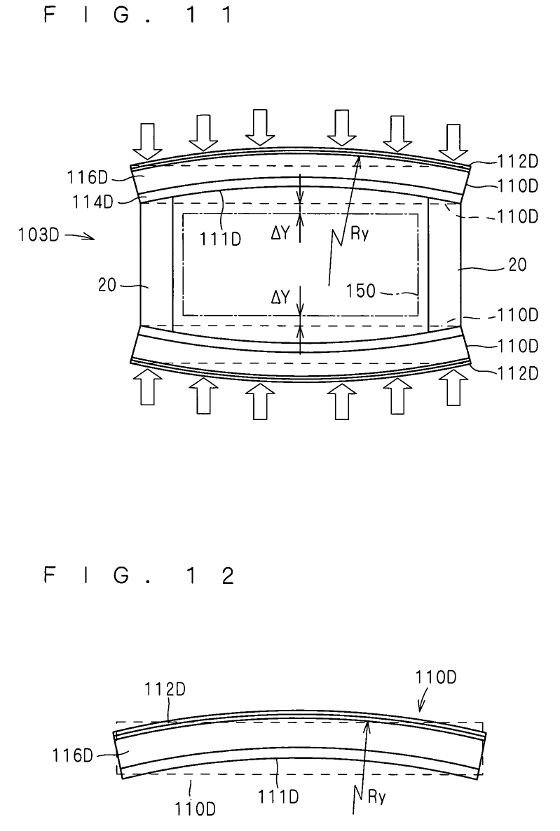

In the present embodiment, although lap welding is carried out with the flange 116af of the third support part 116 and the first support part 112 being overlapped with each other and the flange 116bf and the second support part 114 being overlapped with each other, the flanges 116af and 116bf may be omitted and the edge of a contact portion between the other side edge 116a and the first support part 112 and the edge of a contact portion between the one side edge 116b and the second support part 114 may be welded at weld 115c, as shown in FIG. 8.

Third Preferred Embodiment

FIG. 9 is a perspective view of a color selection electrode assembly frame (hereinafter briefly referred to as “frame”) 103B according to a third preferred embodiment of the invention. Components similar to those of the color selection electrode assembly 101 according to the second preferred embodiment are represented by the same reference characters, explanation of which is thus omitted here, and dissimilar points will be described particularly.

In this frame 103B, at least part of each third support part 116B which corresponds to the third support part 116 has a higher mechanical strength than the first and second support parts 112 and 114. The mechanical strength here refers to difficulty in deformation that is capable of withstanding compressive loads caused by the load P and reaction force R, which is evaluated, for example, by modulus of rigidity or the like.

Providing at least part of the third support part 116B with a high mechanical strength as described above is achieved by increasing the thickness of the part or forming the part of a sheet material having a high mechanical strength.

In the present embodiment, the third support part 116B is divided into a middle support part 116Bm and a pair of end support parts 116Be provided on the both ends. The pair of end support parts 116Be have a greater thickness than the middle support part 116Bm. The difference in thickness causes the end support parts 116Be to have a higher mechanical strength than the middle support part 116Bm. The end support parts 116Be and middle support part 116Bm may be formed of different steel sheets so that the former may have a higher mechanical strength than the latter. The middle support part 116Bm is formed of a sheet material of the same quality and thickness as the frame body 111, and thus, the end support parts 116Be have a higher mechanical strength than the frame body 111.

The border between the end support parts 116Be and middle support part 116Bm may be joined or may not be joined to each other.

As described, the reason why the end support parts 116Be have a higher mechanical strength than the middle support part 116Bm is that, when the color selection electrode body 2 is supported by the first frames 110B under tension, the tension of the color selection electrode body 2 is generally maximized at the respective ends of the first frames 110B.

However, which part of the first frames 110B is to be maximized in mechanical strength is determined by tension distributions of the color selection electrode body 2.

Further, it is needless to say that the third support part 116B may have a higher mechanical strength than the frame body 111 over its entire length.

According to the color selection electrode assembly of the present embodiment, at least part of the third support part 116B has a higher mechanical strength than the first and second support parts 112 and 114, which allows the first frames 110B to be rigidified more. Further, the first and second support parts 112 and 114 may be formed of a steel sheet relatively easy to deform, which thus have a high flexibility. Furthermore, the first and second support parts 112 and 114 may be formed of a relatively thin sheet material, which contributes to weight reduction.

Fourth Preferred Embodiment

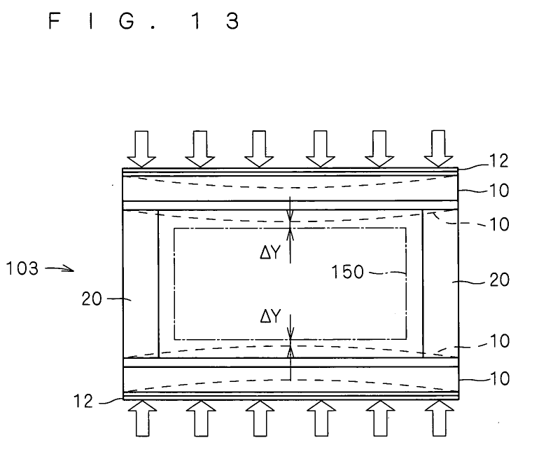

FIG. 10 is a perspective view of a color selection electrode assembly frame (hereinafter briefly referred to as “frame”) 103C according to a fourth preferred embodiment of the invention. Components similar to those of the color selection electrode assembly 101 according to the second preferred embodiment are represented by the same reference characters, explanation of which is thus omitted here, and dissimilar points will be described particularly.

In this frame 103C, each second support part 114C which corresponds to the aforementioned second support part 114 has a width We at its both ends greater than a width Wc at the middle in its longitudinal direction. Particularly, in the present embodiment, the other side edge 114Cb of the second support part 114C is formed to project outwardly so that the second support part 114C has widened portions at the both ends.

Also, a flange 116Cf near one side edge 116Cb of a third support part 116C which corresponds to the third support part 116 is widened at the both ends as compared to the middle in its longitudinal direction. Therefore, the flange 116Cf is in contact with the second support part 114C by a greater area at the both ends in its longitudinal direction as compared to the middle of the first frame 110C in its longitudinal direction, which means a greater number of welds are present at the both ends of each of the first frames 110C.

According to the color selection electrode assembly of the present embodiment, the second support part 114C is widened at the both ends of the first frame 110C, which allows the contact area of the second support part 114C and each of the second frames 20 to be increased. This can increase the joining strength of the first frames 110C and second frames 20. Particularly when the tension of the color selection electrode body 2 is greater at the both ends of the first frames 110C than at the middle in the longitudinal direction, the structure is effectively capable of withstanding the tension.

Fifth Preferred Embodiment

FIG. 11 is an explanatory view of a color selection electrode assembly frame (hereinafter briefly referred to as “frame”) 103D according to a fifth preferred embodiment of the invention as viewed from the side of the stretched surface of the color selection electrode body 2. Components similar to those of the color selection electrode assembly 101 according to the second preferred embodiment are represented by the same reference characters, explanation of which is thus omitted here, and dissimilar points will be described particularly.

In this frame 103D, each first support part 112D which corresponds to the first support part 112 is curved with a radius of curvature Ry expanding opposite to the direction that the tension of the color selection electrode body 2 will work, i.e., outwardly from the center of a screen, in the state which the tension of the color selection electrode body 2 is not yet applied. Also, the edge of each second support part 114D connected to the first support part 112D is curved in line with the curve of the first support part 112D.

Among methods of providing first frames 110D with the radius of curvature Ry is the use of welding strain, for example.

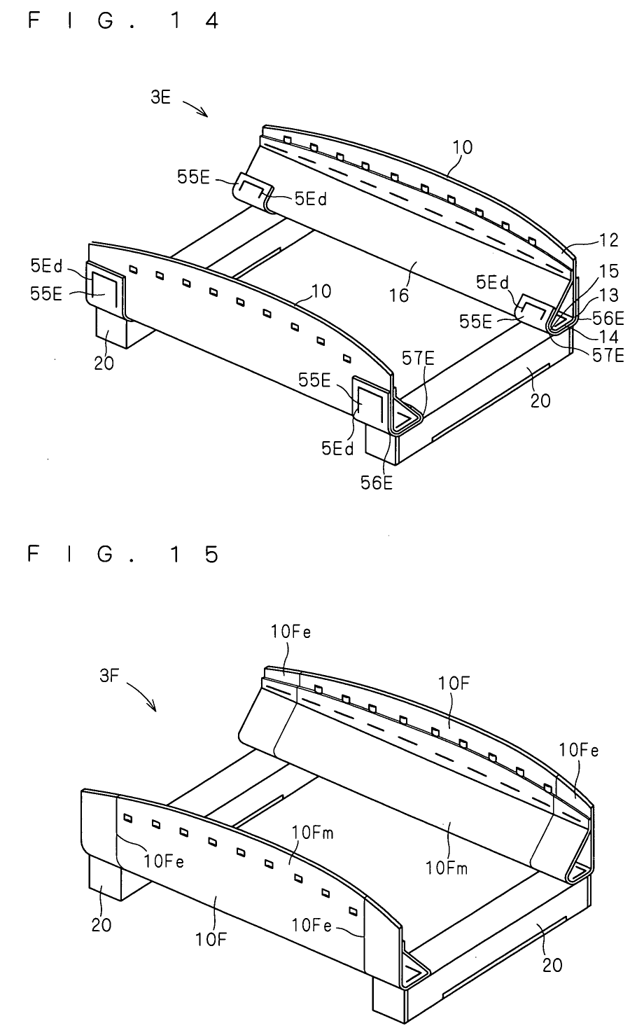

That is, when welding each third support part 116D to each frame body 111D, welding from the side of each third support part 116D causes each first frame 110D of a substantially straight shape as indicated by broken lines in FIG. 12 to be curved with the radius of curvature Ry as indicated by solid lines. This is caused by the phenomenon in which a metallic constitution of a weld is melted and then shrinks through cooling. Welding performed from the side of each third support part 116D causes each third support part 116D to be curved so as to expand outwardly. Particularly, increasing a welding load by extending the total length of welds provided intermittently in the longitudinal direction of the first frames 110D or by performing welding in two lines substantially in parallel to each other allows the radius of curvature Ry to be reduced. On the contrary, when the radius of curvature Ry is to be increased, a welding load may be reduced or welding with a heat load of the same degree may be performed from the opposite side of each third support part 116D.

Then, the color selection electrode body 2 is secured to the pair of first frames 110D while pressing the first frames 110D in the direction that they approach each other. The color selection electrode body 2 is thereby supported between the pair of first frames 110D under a predetermined degree of tension.

At this time, the pair of first frames 110D are pulled by the color selection electrode body 2 in the direction that the first frames 110D approach each other, so as to substantially straighten up as indicated by broken lines in FIG. 11.

Thus, in the state which the color selection electrode body 2 is supported under tension, the degree of inward curvature of each first support part 112D can be reduced, allowing electron beams not to interference the first frames 110D, so that a manufacturing margin can be improved.

This will be described below more specifically.

FIG. 11 shows an outer orbit 150 of electron beams indicated by dash-dot lines in the state which the color selection electrode assembly according to the present embodiment is incorporated into a CRT. Here, the orbit 150 is an orbit as viewed in the direction of the normal to the second support parts 114D of the first frames 110D.

On the other hand, FIG. 13 shows, by way of comparative example, an outer orbit 50 of electron beams indicated by dash-dot lines in the state which the color selection electrode assembly 1 according to the first preferred embodiment is incorporated into a CRT.

In the both cases shown in FIGS. 11 and 13, when the color selection electrode body 2 is supported under tension, the first frames 10 and 110D are subjected to a force indicated by hollow arrows in the respective drawings resulting from the tension of the color selection electrode body 2, and are respectively deformed into the shapes indicated by broken lines in the respective drawings. That is, the first frames 110D of the present embodiment substantially straighten up as shown in FIG. 11 while the first frames 10 of the first preferred embodiment are deformed into a curved shape which expand inwardly.

As is apparent from these drawings, a margin ΔY defined by the space between the orbit 150 of electron beams and the first frames 110D of the present embodiment shown in FIG. 11 is greater than that in the first preferred embodiment shown in FIG. 13. Therefore, the color selection electrode assembly according to the present embodiment provides a greater manufacturing margin from the viewpoint of preventing electron beams from being shadowed by the first frames 110D, which results in a great advantage.

The description of the present embodiment is applicable to the other preferred embodiments including the first preferred embodiment.

Sixth Preferred Embodiment

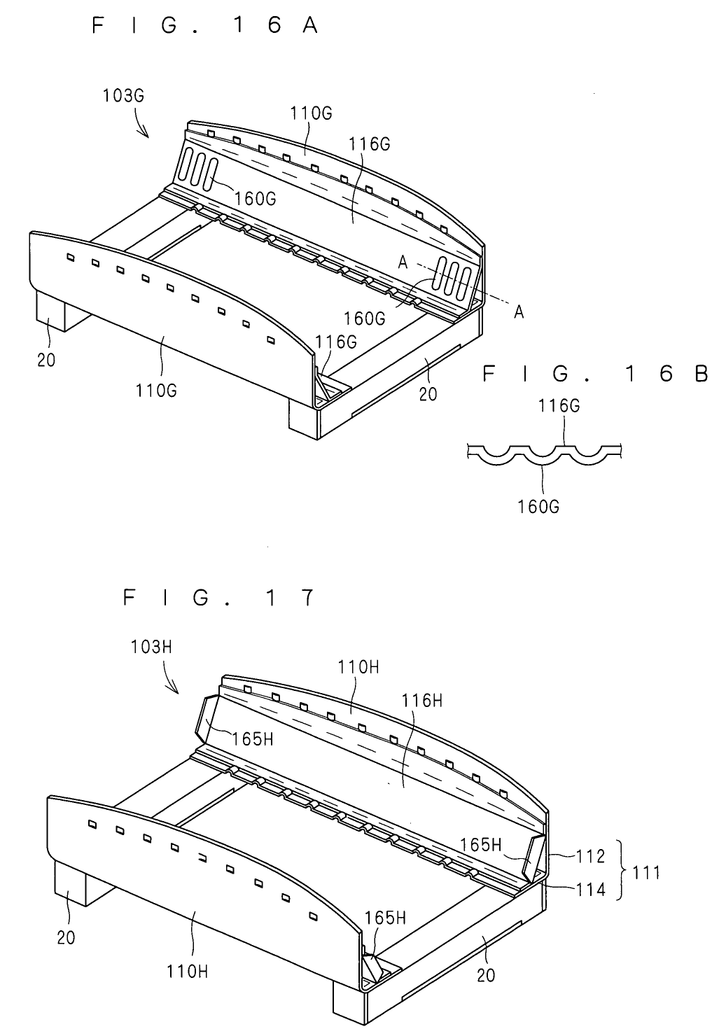

FIG. 14 is a perspective view of a color selection electrode assembly frame (hereinafter briefly referred to as “frame”) 3E according to a sixth preferred embodiment of the invention. Components similar to those of the color selection electrode assembly 1 according to the first preferred embodiment are represented by the same reference characters, explanation of which is thus omitted here, and dissimilar points will be described particularly.

In the frame 3E, holding members 55E are attached to the respective ends of the first frames 10.

The holding members 55E are curved along the periphery of the bottom of the first frames 10 of substantially triangular sectional shape. That is, the holding members 55E are each formed by bending a strip sheet of a predetermined width, and each include a curved holding part 56E along the outline of the bend 13 between the first and second support parts 12 and 14 and a curved holding part 57E along the outline of the bend 15 between the second and third support parts 14 and 16.

The holding members 55E are fit over and joined to the respective ends of the first frames 10 by welds 5Ed.

According to this color selection electrode assembly, the holding members 55E each hold the bend 13 between the first and second support parts 12 and 14 as well as the bend 15 between the second and third support parts 14 and 16. This can reduce stresses imposed on the respective ends of the first frames 10 when a compressive load caused by the load P resulting from the tension T and reaction force R act upon each of the third support parts 16 as shown in FIG. 4. Therefore, the first frames 10 can be rigidified.

The description of the present embodiment is applicable to the other preferred embodiments including the second preferred embodiment. For instance, when applied to the second preferred embodiment, the holding members 55E may each have a holding part in agreement with the shape of the contact portion between each of the second and third support parts 114 and 116.

Seventh Preferred Embodiment

FIG. 15 is a perspective view of a color selection electrode assembly frame (hereinafter briefly referred to as “frame”) 3F according to a seventh preferred embodiment of the invention. Components similar to those of the color selection electrode assembly 1 according to the first preferred embodiment are represented by the same reference characters, explanation of which is thus omitted here, and dissimilar points will be described particularly.

In this frame 3F, a pair of first frames 10F which correspond to the first frames 10 of the first preferred embodiment have a higher mechanical strength at their respective end portions than at their middle portions. The mechanical strength here refers to difficulty in deformation that is capable of withstanding the tension of the color selection electrode body 2.

In the present embodiment, respective end portions 10Fe of each of the first frames 10F are greater in thickness than a middle portion 10Fm. To form such first frames 10F, a sheet is prepared by joining sheet materials (steel, alloy steel) of different thickness adjacently and in parallel to each other by laser welding or the like and pressing the obtained sheet. This kind of structure is also called tailored blank, which is generally used in sheet-metal press for car bodies as well.

Instead of joining sheet materials of different thickness, sheet materials of different mechanical strength (steel, alloy steel) may be joined adjacently and in parallel to each other.

According to this color selection electrode assembly, the portions where a relatively great tension is applied by the color selection electrode body 2 are made mechanically strong, which allows the frame 3F to be rigidified.

Particularly, in an assembly where the end portions 10Fe of the first frames 10F have a higher mechanical strength by thickening, only portions that correspond to the end portions 10Fe need to be thickened and the first frames 10F is not required to be thickened as a whole, resulting in an advantage of achieving both of weight reduction and rigidification.

The description of the present embodiment is applicable to the other preferred embodiments including the second preferred embodiment. For instance, when applied to the second preferred embodiment, the frame body 111 of each of the first frames 110 may be made mechanically strong at the both end portions than at the middle portion.

Eighth Preferred Embodiment

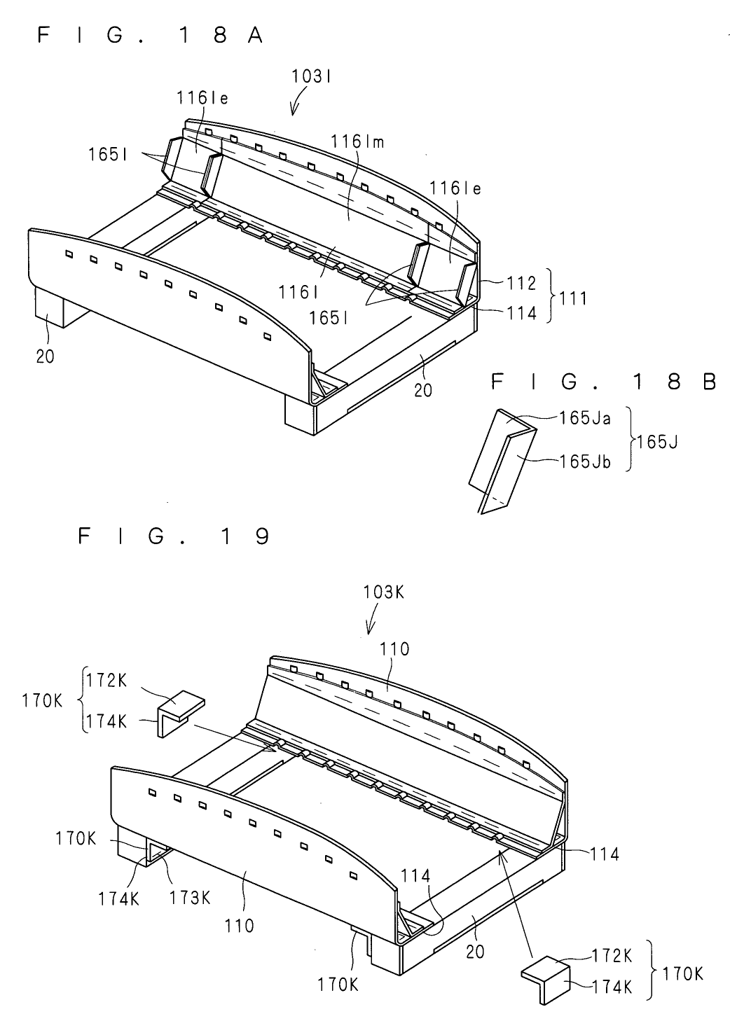

FIG. 16A is a perspective view of a color selection electrode assembly frame (hereinafter briefly referred to as “frame”) 103G according to an eighth preferred embodiment, and FIG. 16B is a sectional view taken along the line A-A of FIG. 16A. Components similar to those of the color selection electrode assembly 101 according to the second preferred embodiment are represented by the same reference characters, explanation of which is thus omitted here, and dissimilar points will be described particularly.

In this frame 103G, third support parts 116G which correspond to the third support parts 116 each have beads 160G extending in their widthwise direction.

The beads 160G are each formed by pressing a sheet material into a long narrow projection toward one side main surface (outer surface) or the other side main surface (inner surface) of each of the third support parts 116G. In the present embodiment, the beads 160G are formed in three lines at regular intervals at the respective end portions of each of the third support parts 116G where the tension of the color selection electrode body 2 tends to be particularly great. This achieves an assembly that copes with buckling deformation of the third support parts 116G in their widthwise direction.

Of course, the beads 160G may be provided at the middle portions of the third support parts 160G in their longitudinal direction. The position and the number of the beads 160G and the like are appropriately adjusted in accordance with the tension distributions of the color selection electrode body 2.

According to the above-described color selection electrode assembly, the third support parts 116G have a great strength against buckling deformation in their widthwise direction. Therefore, even with a compressive load resulting from the load P and reaction force R caused by the tension of the color selection electrode body 2 being applied, the third support parts 116G are unlikely to present buckling deformation, allowing the first frames 110G to be rigidified.

The description of the present embodiment is applicable to the other preferred embodiments including the first preferred embodiment. For instance, when applied to the first preferred embodiment, the beads 160G may be provided at appropriate positions on the third support parts 12 of the first frames 10.

Ninth Preferred Embodiment

FIG. 17 is a perspective view of a color selection electrode assembly frame (hereinafter briefly referred to as “frame”) 103H according to a ninth preferred embodiment of the invention. Components similar to those of the color selection electrode assembly 101 according to the second preferred embodiment are represented by the same reference characters, explanation of which is thus omitted here, and dissimilar points will be described particularly.

In this frame 103H, third support parts 116H which correspond to the third support parts 116 of the second preferred embodiment are each provided with sheet-like reinforcing members 165H.

The reinforcing members 165H are each formed as a sheet extending perpendicularly to each third support part 116H and in the widthwise direction of each third support part 116H.

In the present embodiment, the reinforcing members 165H are provided on the respective ends of each third support part 116H. To form such reinforcing members 165H, the respective ends of each third support part 116H are extended outwardly and the extended portions are bent at a substantially right angle.

The reinforcing members 165H provide the third support parts 116H with a great strength against buckling deformation in their widthwise direction. Therefore, even with a compressive load resulting from the load P and reaction force R resulting from the tension of the color selection electrode body 2, the third support parts 116H are unlikely to present buckling deformation, allowing the first frames 110H to be rigidified.

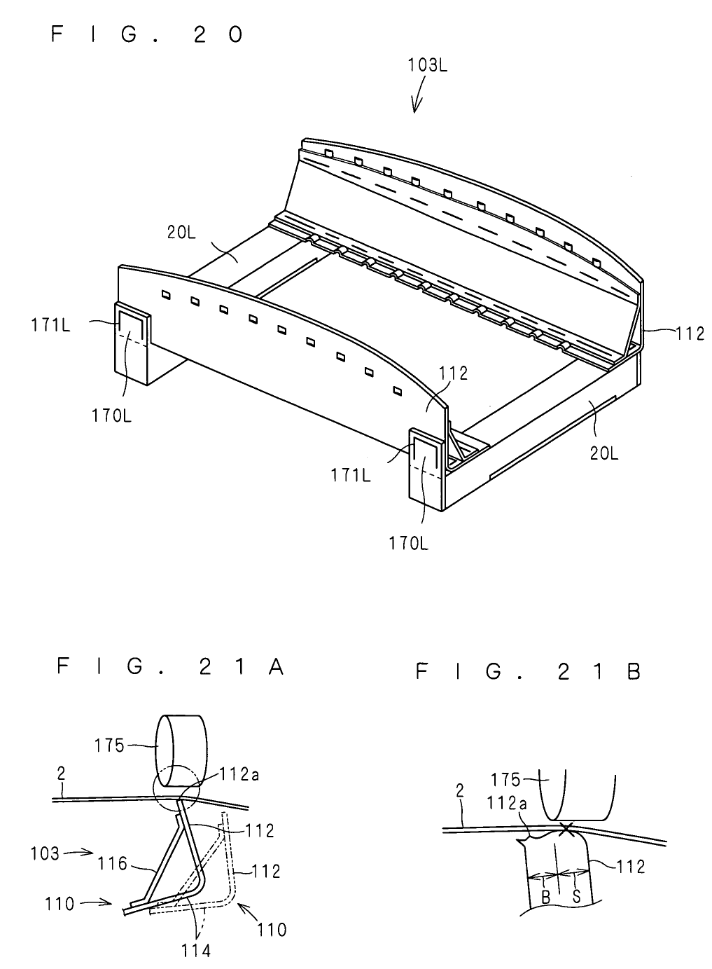

In a frame 1031 shown in FIG. 18A as a variant, third support parts 1161 which correspond to the third support parts 116 of the second preferred embodiment may each be divided into three in their longitudinal direction, i.e., end support parts 116Ie at the both ends and a middle support part 116Im at the middle, and reinforcing members 1651 similar to the reinforcing members 165H may be formed at the respective ends of the support parts 116Ie and 116Im. The borders between the end support parts 116Ie and the middle support part 116Im may or may not be welded together.

Instead of bending the respective ends of the third support parts 116H or support parts 116I1e and 116Im, a reinforcing member 165J shown in FIG. 18B may be secured to each end of the third support parts 116.

FIG. 18B shows the reinforcing member 165J formed by bending a sheet material into a substantially L shape, i.e., as a pair of sheet members 165Ja and 165Jb of a substantially rectangular shape formed integrally to present a substantially L-sectional shape. Overlapping the sheet member 165Ja of the reinforcing member 165J with each end of the third support parts 116 and welding together also allows the third support parts 116 to be reinforced.

The description of the present embodiment is applicable to the other preferred embodiments.

Tenth Preferred Embodiment

FIG. 19 is a perspective view of a color selection electrode assembly frame (hereinafter briefly referred to as “frame”) 103K according to a tenth preferred embodiment of the invention. Components similar to those of the color selection electrode assembly 101 according to the second preferred embodiment are represented by the same reference characters, explanation of which is thus omitted here, and dissimilar points will be described particularly.

In this color selection electrode assembly, connecting members 170K are provided at the respective connecting portions between the first frames 110 and second frames 20 for supporting their connection.

The connecting members 170K are each formed by a first joint part 172K to be joined to each of the first frames 110 and a second joint part 174K to be joined to each of the second frames 20.

In the present embodiment, in each of the connecting members 170K, the first joint part 172K of a substantially rectangular sheet and the second joint part 174K of a substantially rectangular sheet formed integrally into a substantially L shape. The connecting members 170K are each formed by bending a sheet material into a substantially L shape.

The connecting members 170K are provided at the respective connecting portions between the first frames 110 and second frames 20 where their outer surfaces substantially intersect each other. That is, the first joint part 172K is joined to the outer surface of each of the second support parts 114 near the both ends by a weld, and the second joint part 174K is joined to the outer surface of sidewalls of each of the second frames 20 near the respective ends by a weld 173K.

According to this color selection electrode assembly, the connecting members 170K maintain connection between the first frames 110 and second frames 20 more reliably. Therefore, the strength of the frame 103K is improved, so that even when a high stress resulting from the tension of the color selection electrode body 2 acts upon the frame 103K, the frame 103K can sufficiently withstand such stress. Particularly, this brings an advantage of increasing the strength of the frame 103K without the need to thicken sheet materials for the first frames 110 and second frames 20 or without causing weight increase.

Although described as being formed separately from the first frames 110 and second frames 20, the connecting members 170K may be integrally formed with the first frames 110 or second frames 20.

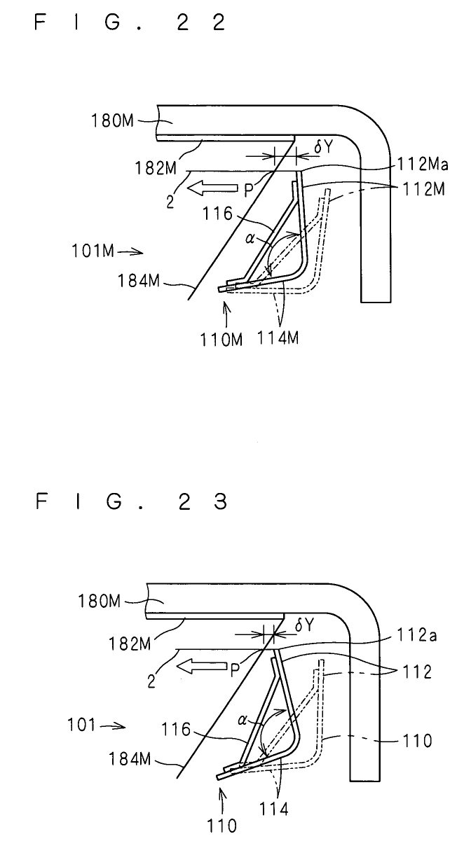

For instance, in a frame 103L shown in FIG. 20 as a variant, the sidewalls of the respective end portions of the second frames 20L are extended along the corresponding side faces of the first frames 110 to form connecting portions 170L. The connecting portions 170L are each joined to the corresponding side faces of the first frames 110 by, for example, welds 171L.

The description of the present embodiment is applicable to the other preferred embodiments.

Eleventh Preferred Embodiment

FIG. 21A is an explanatory view of a secured part between the color selection electrode body 2 and each of the first frames 110 according to an eleventh preferred embodiment of the invention, and FIG. 21B is a partially enlarged view of FIG. 21A. In FIG. 21A, the first frame 110 is in a position indicated by broken lines before supporting the color selection electrode body 2 under tension, and moves to a position indicated by solid lines when supporting the color selection electrode body 2 under tension. Components similar to those of the color selection electrode assembly 101 according to the second preferred embodiment are represented by the same reference characters, explanation of which is thus omitted here, and dissimilar points will be described particularly.

The present embodiment is directed to the securing of the color selection electrode body 2 and first frames 110.

The color selection electrode body 2 is secured to the first frames 110 by the following basic steps. That is, the color selection electrode body 2 is held by its periphery and pressed against the one side edge 112a of the first support part 112. At the same time, the pair of first frames 110 are pressed in the direction that they approach each other. In this state, a welding electrode 175 is pressed onto the color selection electrode body 2 at a contact portion between the color selection electrode body 2 and the one side edge 112a for securing the color selection electrode body 2 to the one side edge 112a by seam welding or the like. Thereafter, the periphery of the color selection electrode body 2 is removed, whereby the securing of the color selection electrode body 2 is completed.

Here, a sheet material of a predetermined shape to be an original of the first frames 110 is formed by press-shearing of a parent sheet material into the predetermined shape. Therefore, the one side edge 112a of the first support part 112 has a first end-face region S including a shear drop and a shear plane formed by press-shearing and a second end-face region B including a fracture surface. A shear drop is a free surface depressed by a shearing lip biting into a material until moment before shearing phenomenon occurs. A shear plane is a surface formed by the shearing phenomenon. A fracture surface is a rough surface containing cracks.

In the present embodiment, the first end-face region S is arranged on the outer side of the frame 103 with respect to the second end-face region B. Then, the color selection electrode body 2 is secured to the first end face region S, more specifically, to the top of the first end-face region S (see the mark X in FIG. 21B).

Since the color selection electrode body 2 is secured to the first end-face region S having little surface roughness, such securing can achieve a sufficient positional accuracy without the need to carry out machine finishing. Therefore, the color selection electrode assembly 101 can be obtained with a sufficient accuracy at low costs.

More specifically, when press-shearing a sheet material, a rough fracture surface appears on its end face. Thus, a shear plane and a fracture surface of a press-sheared surface need to be ground by machining by approximately several millimeters to give a smooth finish, where the color selection electrode body 2 needs to be welded.

However, as in the present embodiment, securing the color selection electrode body 2 by welding or the like to the first end-face region S including a relatively flat shear drop and a shear plane rather than to the second end-face region B including a rough fracture surface allows the color selection electrode body 2 to be secured and supported with a sufficient positional accuracy without machine finishing.

As a sheet material for components including the first support parts 112, a dual phase stainless steel or precipitation hardening stainless steel is preferably used, for example. This is because, when shearing these sheet materials, a relatively flat surface close to a cleavage plane can be obtained as a shear plane.

As a method of welding avoiding the second end-face region B including a fracture surface, shearing is conducted such that the shear plane and shear drop are on the outer side of the frame 103, and when pressing the pair of first frames 110 in the direction that they approach each other, the color selection electrode body 2 is held by its periphery and is pulled toward the second support parts 114 with the one side edge 112a of the first support part 112 inclined toward the inside of the frame 103. Then, the color selection electrode body 2 is pressed against the first end-face region S. In this state, bringing the welding electrode 175 of a cylindrical cross-sectional shape into contact with the contact portion between the color selection electrode body 2 and the first end-face region S from on top of the color selection electrode body 2, the color selection electrode body 2 can be stably welded to the first end-face region S avoiding the second end-face region B.

Further, in the present embodiment, when the first frames 110 and second frames 20 are assembled to form a frame and the respective ends are joined together, it is preferable that welding strain should be small and the amount of distortion of the stretched surface should lie within a predetermined allowable range. Here, the amount of distortion is defined by the difference in height between a reference plane decided by arbitrary three of four corners of the color selection electrode body 2 and the remaining one of the four corners. This is achieved by, for example, employing laser welding for welding which will be described later the respective components and frame 103.

The description of the present embodiment is applicable to the other preferred embodiments.

Twelfth Preferred Embodiment

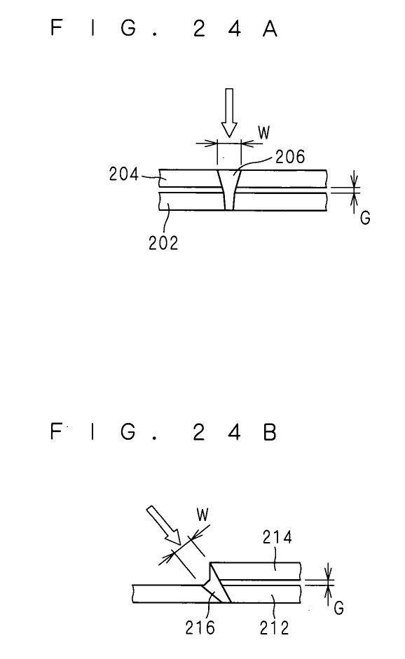

FIG. 22 is a sectional view of an essential part of a color selection electrode assembly 101M according to a twelfth preferred embodiment of the invention. In FIG. 22, a first frame 110M is in a position indicated by broken lines before supporting the color selection electrode body 2 and is moved to a position indicated by solid lines when supporting the color selection electrode body 2. Components similar to those of the color selection electrode assembly 101 according to the second preferred embodiment are represented by the same reference characters, explanation of which is thus omitted here, and dissimilar points will be described particularly.

In the color selection electrode assembly 101M according to the present embodiment, a first support part 112M and a second support part 114 in the first frame 110M which corresponds to the first frame 110 makes an angle α greater than 90°.

In the state which the color selection electrode body 2 is secured to one side edge 112Ma of the first support part 112M of the first frame 110M, the first frame 110M is displaced toward the inside of a frame 103M under the tension of the color selection electrode body 2 (indicated by a hollow arrow in FIG. 22).

FIG. 23 shows a comparative example in which the first support part 112 and second support part 114 of the first frame 110 make substantially the right angle.

In FIGS. 22 and 23, in the state which the color selection electrode assemblies 101 and 101M are mounted on a CRT 180M, an orbit 184M of electron beams scanning at the edge of a phosphor surface 182M is as shown in FIGS. 22 and 23. The distance between a position P at which the orbit 184M passes through the color selection electrode body 2 and the one side edge 112a of the first support part 112 in the first frame 110 and the distance between the position P and the one side edge 112Ma of the first support part 112M in the first frame 110M shall be defined as δY.

In FIG. 23 showing a comparative example, the tension of the color selection electrode body 2 causes the one side edge 112a of the first support part 112 to be inclined toward the inside of the frame 103, causing the distance δY to be relatively small.

On the other hand, in FIG. 22 according to the present embodiment, the first support part 112M and second support part 114 make the angle α greater than 90°, allowing the distance δY to be relatively great even when the one side edge 112Ma of the first support part 112M is displaced toward the inside of the frame 113M under the tension of the color selection electrode body 2. Therefore, even when wrinkles due to thermal strain at the weld between the color selection electrode body 2 and first support part 112M occur at the periphery of the color selection electrode body 2, such wrinkles due to thermal strain are not likely to occur in a region of the color selection electrode body 2 that contributes to display of the CRT. Thus, the color selection electrode body 2 is not likely to be influenced by wrinkles and the like due to thermal strain at the weld, allowing a manufacture margin to be increased. Further, from a different point of view, the region where electron beam holes are formed on the color selection electrode body 2 can be widened, allowing the screen size of the phosphor surface 182M to be widened, which is advantageous in terms of a design margin for a CRT.

The description of the present embodiment is applicable to the other preferred embodiments.

Thirteenth Preferred Embodiment

A thirteenth preferred embodiment is directed to a joining technique of sheet materials which is applicable to the above-described preferred embodiments. This technique is applied, for example, to the connected portions between the first frames 10 and second frames 20 (e.g., the welds between each flange 16f and first support part 12) in the first preferred embodiment.

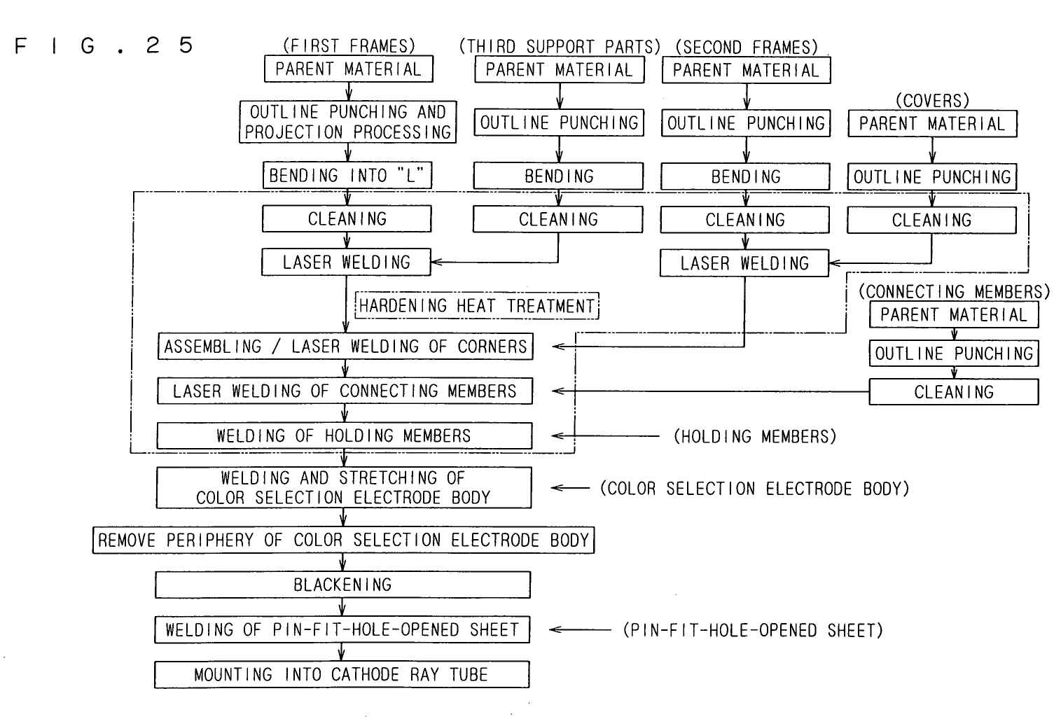

FIGS. 24A illustrates a sectional structure of a fusion zone 206 after overlapping steel sheets 202 and 204 to which laser beam is radiated in the direction indicated by a hollow arrow.

FIG. 24B illustrates a sectional structure of a fusion zone 216 after radiating laser beam to the corner between steel sheets 212 and 214 overlapped with each other in the direction indicated by a hollow arrow. In the respective drawings, the dimension W is the width of the fusion zone 206 or 216 as viewed in the direction in which laser beam is radiated, and the dimension G is a clearance between the steel sheets 202 and 204 or that between the steel sheets 212 and 214.

Test pieces having a thickness ranging from 0.7 to 1.8 mm were subjected to laser welding under the condition which the clearance G was equal to or below one-tenth of the sheet thickness while varying the weld length as 10, 20 and 30 mm. Then, it was found out that, provided that the width W of the fusion zone 206 or 216 (hereinafter also referred to as fusion width) was not greater than 2 mm, two overlapped sheets remaining flat after welding without causing warps could be obtained.

Further, under such welding condition of fusion width that causes no warp, welding was carried out for the first frames 10 and second frames 20, respectively, and for assembling the first and second frames 10 and 20 into a rectangular frame, while the weld line at each of the welds such as welds 5 in the color selection electrode assembly 1 shown in FIG. 1 was determined to be not greater than 30 mm. As a steel sheet, a dual phase stainless steel having a thickness of 1.2 mm was used. In addition, the size of the color selection electrode assembly 1 was set at a frame for a 34-inch CRT (diagonal dimension: 80 cm).

In this case, the amount of distortion at the four corners of the color selection electrode body 2 (i.e., the difference in height between a reference plane decided by arbitrary three of the four corners and the remaining one) was not greater than 0.15 mm, which was good.

The same welding was also carried out for the color selection electrode assembly 101 shown in FIG. 2 to obtain the same results.

This shows that welding sheet materials together at weld lines having a fusion width not greater than 2 mm in the manufacturing of the color selection electrode assembly 101 can reduce warps of the sheet materials, allowing reduction in amount of distortion of the color selection electrode assembly 101.

Although the example of employing laser welding has been described, other welding methods may be used if attention is paid to avoid an excessive heat input.

Fourteenth Preferred Embodiment

In a fourteenth preferred embodiment, description will be made on sheet materials constituting the first frames 10, 110, 110B, 110C, 110D, 10F, 110G, 110H and 110M and the second frames 20 and 20L and examples of processing such materials, as a technique which is applicable to the above-described preferred embodiments.

As sheet materials for these frames, a dual phase stainless steel NSS431-DP2 (a product of Nisshin Steel Co., Ltd., a 16.5%Cr-2%Ni dual-phase stainless steel comprised of ferritic phase and martensitic phase) or a precipitation hardening stainless steel SUS631 (a 17%Cr-7%Ni-1% Al steel) may be employed.

These steel sheet materials are improved in mechanical properties by heat treatment at 450 to 500° C.

Here, these steel sheet materials were subjected to heat treatment at 470° C. for 15 minutes for comparison of properties before and after the heat treatment. The heat treatment includes blackening, age hardening treatment and precipitation hardening heat treatment at 450 to 500° C. The results are shown in table 1.

TABLE 1

| Mechanical properties | NSS431 | SUS631 |
|---|---|---|
| Before heat treatment | | |
| 0.2% yield strength (MPa) | 925 | 1000 |
| Vickers hardness (Hv) | 378 | 410 |
| After heat treatment | | |
| High temperature creep elongation (%) | 0.5 | 1.0 |
| 0.2% yield strength (MPa) | 1125 | 1250 |
| Vickers hardness (Hv) | 390 | 530 |
| High temperature creep elongation (%) | 0.04 | 0.05 |

The 0.2% yield strength is defined as a load per unit cross section that causes a 0.2% permanent elongation. The high temperature creep elongation is defined by a permanent elongation obtained by stretching a test piece under a stress of 350 MPa for one hour in a 500° C. atmosphere, following which the load is removed, and which is returned to a normal temperature.

Table 1 shows that the heat treatment performed on the above steel sheets increases the 0.2% yield strength and Vickers hardness while reducing the high temperature creep elongation, resulting in increased hardness as well as improved mechanical strength.

Therefore, the first frames 10, 110, 110B, 110C, 110D, 10F, 110G, 110H and 110M and second frames 20 and 20L are substantially formed of one of a dual phase stainless steel comprised of ferritic phase and martensitic phase and a precipitation hardening stainless steel, and are subjected to at lest one of blackening, age hardening treatment and precipitation hardening heat treatment at 450 to 500° C., so that the following effects can be obtained.

That is, the increase in the 0.2% yield strength and Vickers hardness is advantageous in that, in the case of manufacturing a thinner frame, the frame resists a force applied to the one side edge of each first support part (a contact pressure as indicated by Hertz's formula in the strength of materials) when supporting the color selection electrode body 2 under tension and a force applied to the frame by supporting the electrode body 2 under tension.

Further, the reduction in high temperature creep elongation is advantageous in controlling a reduction in the tension of the color selection electrode body 2 due to creep deformation of the color selection electrode body in a heat treatment step at 300 to 500° C. in the manufacture of the color selection electrode assembly and CRT.

Fifteenth Preferred Embodiment

In a fifteenth preferred embodiment, description will be made on the relationship between the color selection electrode body 2 and first frames 10, 110, 110B, 110C, 110D, 10F, 110G, 110H or 110M in terms of thermal expansion coefficient, as a technique which is applicable to the above-described preferred embodiments.

It is preferable that the difference in thermal expansion coefficient between the color selection electrode body 2 and first frames 10, 110, 110B, 110C, 110D, 10F, 110G, 110H or 110M in temperatures ranging from a normal temperature to 500° C. should be within 10%. Here, a normal temperature is defined as 15 to 20° C.

A thermal expansion coefficient is adjusted by appropriately changing the shapes and selecting the materials of the color selection electrode body 2 and first frames 10, 110, 110B, 110C, 110D, 10F, 110G, 110H or 110M.

Controlling the difference in thermal expansion coefficient to be within 10% as described above can prevent wrinkles in the color selection electrode body 2 resulting from the difference in the amount of thermal expansion (or contract) between the one side edge 12a or 112a of the first support part 12 or 112 in the first frames 10, 110, 110B, 110C, 110D, 10F, 110G, 110H or 110M and the color selection electrode body 2 joined intermittently along the extending direction of the one side edge 12a or 112a.

Sixteenth Preferred Embodiment

In a sixteenth preferred embodiment, a method of manufacturing a color selection electrode assembly will be described.

FIG. 25 is a flow chart of manufacturing steps of a color selection electrode assembly. Although this flow chart shows steps of manufacturing the color selection electrode assembly 101 according to the second preferred embodiment, the color selection electrode assembly 101 according to the other preferred embodiments is also manufactured basically through the same steps.

The steps of manufacturing the color selection electrode assembly 101 includes the steps of: (a) pressing a sheet material to form the pair of first frames 110 and pair of second frames 20; (b) joining the pair of first frames 110 and pair of second frames 20 into a rectangular frame; and (c) securing the color selection electrode body 2 to the pair of first frames 110 while pressing the side faces of the pair of first frames 110 in the direction that they approach each other, and thereafter releasing the pressure imposed on the pair of first frames 110.

The step (a) includes the steps of forming the first frames 110 and forming the second frames 20.

In the step of forming the first frames 110, first, portions of a predetermined outline are punched from a parent sheet material by pressing, to form the projections 30. Next, the frame bodies 111 are formed by predetermined pressing such as bending the sheet material into a substantially L shape, and the components are subjected to degreasing cleaning. Separately, portions of a predetermined outline are punched from a parent sheet material by pressing, and are subjected to predetermined bending press, to form the third support parts 116, which are then subjected to degreasing cleaning. Then, the third support parts 116 are joined to the corresponding frame bodies 111, respectively, by laser welding or the like. The first frames 110 are thereby formed.

On the other hand, in the step of forming the second frames 20, first, portions of a predetermined outline are punched from a parent sheet material by pressing, and are subjected to predetermined bending press, to form the frame bodies 22, which are then degreased. Separately, portions of a predetermined outline are punched from a parent sheet material by pressing to form the covers 24, which are then degreased. Then, the covers 24 are joined to the frame bodies 22, respectively, by laser welding or the like. The second frames 20 are thereby formed.

In the step (b), the first frames 110 and second frames 20 are assembled into a rectangular frame and respective corners are joined together by laser welding or the like. Thereafter, the connecting members 170K or holding members 55E are joined by laser welding or the like, as necessary.

In the step (c), the color selection electrode body 2 is secured to the pair of first frames 110 by seam welding or the like while the side surfaces of the pair of first frames 110 are pressed in the direction that they approach each other. Thereafter, the pressure imposed on the pair of first frames 110 is released, whereby the color selection electrode body 2 is securely supported by the pair of first frames 110 under tension.

The outer periphery of the color selection electrode body 2 is thereafter removed. In this way, the color selection electrode assembly 101 is manufactured.

The color selection electrode assembly 101 is subjected to blackening at 450 to 500° C. and welding for joining a pin-fit-hole-opened sheet to which pins provided in a CRT panel are fitted to the holding members or the like. The color selection electrode assembly 101 is incorporated in a CRT, and the CRT is manufactured.

The basic steps of manufacturing the color selection electrode assembly 101 are as described above.

Preferably, a heat treatment step of heating the first frames 110 and second frames 20 at 450 to 500° C. is performed after pressing sheet materials in the step (a) and before the step (c).

That is, one heat treatment step of heating the first and second frames 110 and 20 at 450 to 500° C. is preferably performed after pressing sheet materials and before pressing the first frames 110 for securing the color selection electrode body 2 thereto.

In the flow chart shown in FIG. 25, such heat treatment step is preferably performed in any one of steps surrounded by dash-dot lines.

As a parent sheet material, it is preferable to employ a steel sheet formed of a dual phase stainless steel or precipitation hardening stainless steel as described in the fourteenth preferred embodiment.

That is, undergoing a heat treatment step at 450 to 500° C., a steel formed of a dual phase stainless steel or precipitation hardening stainless steel is improved in mechanical strength. Therefore, pressing involving punching of a predeterminedly shaped portions and drawing such as bending or forming projections is performed before the heat treatment, whereby press productivity is improved. Then, the heat treatment is performed after pressing, which allows the frame to be rigidified.

To improve the weldability in welding the color selection electrode body 2 to the frame, the heat treatment is preferably performed in an unoxidized environment such as vacuum or nitrogen gas environment.

Example

An example of applying the color selection electrode assembly 1 described in the first preferred embodiment to a 34-inch CRT will be described hereinbelow.

As a frame material for the first frames 10 and second frames 20, a dual phase stainless steel NSS431-DP2 of 1.2 mm thickness (a product of Nisshin Steel Co., Ltd., a 16.5%Cr-2%Ni stainless steel comprised of ferritic phase and martensitic phase) was employed.

The projections 30 were formed in the shape shown in FIG. 3A having a width W of 6 mm, a height H of 3 mm and projecting dimension D of 1.2 mm. Here, nine projections 30 are provided with appropriate spacing along the longitudinal direction of the first support part 12, as shown in FIG. 1. Then, an overlapped region between the flange 16f of each of the third support parts 16 and the bottom of each of the projections 30 on each of the first support parts 12 was welded by CO₂ laser welding. The welds 5 were generated intermittently along the extending direction of the overlapped region. The welds 5 each had a weld length of 5 mm and a weld pitch of 100 mm. However, the welds 5 at the both ends of the overlapped region each had a weld length of 20 mm.

Laser was radiated from the side of the flange 16f of each of the third support parts 16 with an output of 2500 W and a pulse wave of welding speed of 2 m/min. In this case, the fusion zone had a width of 1 to 1.5 mm and such a depth that reached the outer surface of each of the first support parts 12 on the opposite side of laser radiation, which means fusion sufficiently occurred.

The first frames 10 and second frames 20 were also joined together by laser welding at continuous welds of a rectangular shape at the overlapped portions of the first frames 10 and second frames 20 and welds at fillet welds between the first frames 10 and second frames 20.

Laser radiation was carried out through the openings of the both end portions on the rear side of each of the second frames 20. Therefore, the covers 24 were joined to the second frames 20, respectively, so that the openings were formed on the both end portions of each of the second frames 20 on the rear side.

Welding here was carried out with an output of 2500 W and a continuous wave of a welding speed of 1 m/min. In this case, the fusion zone had a width of 1.5 to 2 mm and extended from the second support part 14 of the bottom of each of the first frames 10 to reach the inside of each of the second frames 20.

The color selection electrode body 2 formed of a low-carbon cold-rolled steel of 0.13 mm thickness was supported by the frame 3 of such structure under tension. For the color selection electrode body 2, the color selection electrode body 2C with the electron beam holes 2a as shown in FIG. 2C was used. When supported under tension, the color selection electrode body 2 was placed under a tension having distributions of 10-40 N/mm (total load of 12000 N) along the longitudinal direction of the first frames 10.

Then, the predetermined holding members 55E were attached to the three corners of the frame 3, and the color selection electrode assembly 1 was incorporated into a CRT, which was thereafter mounted to a television set.

This allowed a good CRT to be obtained without problems concerning screen vibrations (vibrations of the color selection electrode body 2) due to vibrations of speaker sound. The frame 3 was 2 kg in weight in this case.

For a comparative example with a conventional structure, the structure described in the first preferred embodiment was formed to be in conformity with a conventional structure where the first frames 10 are not provided with the projections 30. In this case, to withstand a load created by the same tension as mentioned above, the first frames 10 needs to be welded over the entire length, and the first frames 10 and the like needs to be of 1.8 mm thickness. Therefore, the frame 3 was 3 kg in weight.

The present example and comparative example show that the weight of the frame 3 was reduced from about 3 kg in the conventional structure to about 2 kg, allowing significant weight reduction.

It has been confirmed that the color selection electrode assembly 1 with the frame 3 formed as described above employing a precipitation hardening stainless steel SUS631 (17%Cr-7%Ni-1%Al steel) provides a predetermined performance.

While the invention has been shown and described in detail, the foregoing description is in all aspects illustrative and not restrictive. It is therefore understood that numerous modifications and variations can be devised without departing from the scope of the invention.

What is claimed is:

1. A frame for a color selection electrode assembly for supporting a color selection electrode body under tension, comprising
at least two support parts joined together at a predetermined angle, wherein
at least one projection having a convex surface and at least one shear plane is formed on one of said support parts, and
an edge of the other one of said support parts is arranged to be in contact with a main surface of said one of said support parts and said shear plane.

2. A frame for a color selection electrode assembly for supporting a color selection electrode body under tension, comprising:
a pair of first frames; and
a pair of second frames for holding said pair of first frames substantially in parallel to each other with a predetermined space therebetween, wherein
said pair of first frames are each formed in a substantially triangular sectional shape, each including a first support part having one side edge to which said color selection electrode body is secured, a second support part having one side edge connected to the other side edge of said first support part through a bend, and a third support part having one side edge connected to the other side edge of said second support part through a bend, and
at least one projection having a convex surface and at least one shear plane is formed in an inner position of the one side edge of said first support part, and the other side edge of said third support part is arranged to be in contact with a main surface of said first support part and said shear plane.

3. The frame according to claim 2, wherein
when there is no load created by tension of said color selection electrode body, said first support part is curved arcuately to expand in a direction opposite to a direction that the tension of said color selection electrode body works.

4. The frame according to claim 2, wherein
a holding member is attached to each of said pair of first frames, said holding member including a curved holding part along the outline of said bend between said first and second support parts and a holding part along the outline of said bend between said second and third support parts.

5. The frame according to claim 2, wherein
at least end portions of said first and second support parts are mechanically stronger than the middle portions thereof.

6. The frame according to claim 2, wherein
said third support part has a bead formed thereon extending in the widthwise direction thereof.

7. The frame according to claim 2, wherein
a sheet-like reinforcing member is provided for said third support part, said reinforcing member being substantially perpendicular to said third support part and extending along the widthwise direction of said third support part.

8. The frame according to claim 2, wherein
a connecting member is provided at each of connected portions between said pair of first frames and said pair of second frames for supporting connection.

9. The frame according to claim 2, wherein
said first support part and said second support part make an angle greater than 90 degrees.

10. The frame according to claim 2, wherein
said pair of second frames are formed by bending, and
at least one of an extending direction of said bend of each of said pair of first frames and that of said bend of each of said pair of second frames is substantially perpendicular to a rolling direction of a parent sheet material for said pair of first frames and said pair of second frames.

11. The frame according to claim 2, wherein
a connected portion between sheet materials include a weld line having a fusion width equal to or smaller than 2 mm.

12. The frame according to claim 2, wherein
at least one of said pair of first frames and said pair of second frames is formed of one of a dual phase stainless steel substantially comprised of ferritic phase and martensitic phase and a precipitation hardening stainless steel, and is subjected to at least one of blackening, age hardening treatment and precipitation hardening heat treatment at temperatures ranging from 450 to 500° C.

13. The frame according to claim 2, wherein
the one side edge of said first support part has a shear drop, a shear plane and a fracture surface created by press-shearing, said shear drop and said shear plane being provided on an outer side of said first support part with respect to said fracture surface, and
said color selection electrode body is securely supported at said shear drop and said shear plane.

14. The frame according to claim 2, wherein
a thermal expansion coefficient of said pair of first frames under a temperature condition ranging from a normal temperature to 500° C. is defined in such a range that a difference from a thermal expansion coefficient of said color selection electrode body under said temperature condition is within 10%.

15. A frame for a color selection electrode assembly for supporting a color selection electrode body under tension, comprising:
a pair of first frames; and
a pair of second frames for holding said pair of first frames substantially in parallel to each other with a predetermined space therebetween, wherein
said pair of first frames are each formed in a substantially triangular sectional shape, each including a frame body in a substantially L-sectional shape having a first support part having one side edge to which said color selection electrode body is secured and a second support part having one side edge connected to the other side edge of said first support part through a bend, and a third support part for covering an open side of said frame body opposite to said bend,
at least one first projection having a convex surface and at least one shear plane is formed in an inner position of the one side edge of said first support part, while at least one second projection having a convex surface and at least one shear plane is formed in an inner position of the other side edge of said second support part, and
the one side edge of said third support part is arranged to be in contact with a main surface of said second support part and said shear plane of said second projection, while the other side edge of said third support part is arranged to be in contact with a main surface of said first support part and said shear plane of said first projection.

16. The frame according to claim 15, wherein
at least part of said third support part is mechanically stronger than said first and second support parts.

17. The frame according to claim 15, wherein
said second support part is wider at end portions thereof than at a middle portion thereof.

18. The frame according to claim 15, wherein
said third support part has a bead formed thereon extending in the widthwise direction thereof.

19. The frame according to claim 15, wherein
a connecting member is provided at each of connected portions between said pair of first frames and said pair of second frames for supporting connection.

20. The frame according to claim 15, wherein
at least one of said pair of first frames and said pair of second frames is formed of one of a dual phase stainless steel substantially comprised of ferritic phase and martensitic phase and a precipitation hardening stainless steel, and is subjected to at least one of blackening, age hardening treatment and precipitation hardening heat treatment at temperatures ranging from 450 to 500° C.

21. A method of manufacturing a color selection electrode assembly, comprising the steps of:
(a) forming a pair of first frames and a pair of second frames by pressing a sheet material;
(b) joining said pair of first frames and said pair of second frames to form a rectangular frame;
(c) securing a color selection electrode body to said pair of first frames while pressing side faces of said pair of first frames in the direction that they approach each other, and thereafter releasing a pressure imposed on said pair of first frames; and
(d) performing heat treatment for heating said pair of first frames and said pair of second frames at temperatures ranging from 450 to 500° C. after pressing in said step (a) and before said step (c).
